(19) United States
(12) Patent Application Publication
(10) Pub. No.: US 2015/0224815 A1
(43) Pub. Date: Aug. 13, 2015

(54) TRANSFER TOOL AND REFILL FOR TRANSFER TOOL

(71) Applicant: KOKUYO S&T CO., LTD., Osaka-shi, Osaka (JP)

(72) Inventors: Daiki Kishimoto, Osaka-shi (JP); Hideto Shima, Osaka-shi (JP); Kousuke Kato, Osaka-shi (JP)

(21) Appl. No.: 14/427,962

(22) PCT Filed: Sep. 12, 2013
(86) PCT No.: PCT/JP2013/074618

§ 371 Date: Mar. 12, 2015

(30) Foreign Application Priority Data
Sep. 13, 2012 (JP) 2012-201945

(51) Int. Cl. B43L 19/00; B43M 11/06

(52) U.S. Cl. CPC B43L 19/00; B43M 11/06

(57) ABSTRACT

A transfer tool 1 according to the present invention is configured so that a refill 3 has a feeding reel 32 on which a transfer tape T is wound and a rotation-inhibiting mechanism X to inhibit rotation of the feeding reel 32 when the feeding reel 32 is not held in a transfer tool main body 2, the rotation-inhibiting mechanism X being able to permit rotation of the feeding reel 32 with loading the transfer tool main body 2 with the feeding reel 32 when the feeding reel 32 is attached to the transfer tool main body 2.

### TECHNICAL FIELD

The present invention relates to a transfer tool with a refill and the refill for the transfer tool that has a reel to wind a transfer tape provided with a transfer substance and a rotation-inhibiting mechanism to inhibit rotation of the reel when it is not in use.

### BACKGROUND ART

A transfer tool which includes a refill having at least a reel to wind and hold a transfer tape and is configured so that the refill is detachable from a transfer tool main body is conventionally well-known. In order to prevent the reel from unnecessarily rotating and loosening the tape or the like during transportation and so on, such transfer tools have generally been distributed in the form that a rotation-inhibiting member composed of thick paper or the like to be insertable into the reel is inserted, or in the form that a mount for wrapping the refill is provided with a rotation-inhibiting structure to be engaged with the reel and the mount is engaged with the refill (See Patent Document 1, for example).

Also, there have been proposed transfer tools in which a mechanism for inhibiting rotation is previously provided on the refill and a releasing mechanism for release the inhibiting mechanism is provided on the transfer tool main body so as to prevent the refill from being loosened during transportation and so on without using the rotation-inhibiting member as described above, the releasing mechanism releasing the inhibiting mechanism through a movement performed when attaching the refill to the transfer tool main body or in the term, which includes the time at which opening a cap or the like, between attaching the refill and using it (See Patent Document 2 and 3, for example).

However, the constitution of the above-described transfer tool becomes complex or a problem occurs that the flexibility in utilization of an inner space of the transfer tool main body is decreased because it is required that a special mechanism for removing the inhibition against rotation of the reel be provided on the main body in the above-described one.

### RELATED ART DOCUMENTS

### Patent Documents

Patent document 1: Japanese Unexamined Patent Application Publication No. 2009-029054.

Patent document 2: Japanese Unexamined Patent Application Publication No. 2010-017855.

Patent document 3: Japanese Unexamined Patent Application Publication No. 2011-121203.

### SUMMARY OF THE INVENTION

### Problems to be Solved by the Invention

The present invention has paid attention to the above-described flaws, it is an object of the present invention to provide a transfer tool and a refill to be used for the transfer tool that can achieve both preventing a reel from unnecessary rotating by the refill itself during transportation and permitting rotation of the reel smoothly when in use with a simple constitution of a transfer tool main body.

### Means of Solving the Problems

In order to realize the above object, the present invention has prepared the following means.

Specifically, a transfer tool according to the present invention is characterized in that it includes a transfer tool main body capable of accommodating a transfer tape that is able to transfer a transfer substance onto a transfer target by pressing the transfer tape against the transfer target in a state of wrapping the transfer tape around a transfer head and a refill capable of being installed on the transfer tool main body, the refill having a reel to wind the transfer tape and a rotation-inhibiting mechanism to inhibit rotation of the reel when the reel is not held in the transfer tool main body, the rotation-inhibiting mechanism being able to permit rotation of the reel with loading the transfer tool main body with the reel when the reel is attached to the transfer tool main body.

Also, a refill according to the present invention is characterized in that it is to be used while at least a part of the refill is put in a transfer tool main body capable of accommodating a transfer tape that is able to transfer a transfer substance onto a transfer target by pressing the transfer tape against the transfer target in a state of wrapping the transfer tape around a transfer head, the refill including a reel to wind the transfer tape and a rotation-inhibiting mechanism to inhibit rotation of the reel when the reel is not held in the transfer tool main body, the rotation-inhibiting mechanism being able to permit rotation of the reel with loading the transfer tool main body with the reel when the reel is attached to the transfer tool main body.

With such configuration, since the rotation-inhibiting mechanism is provided to permit rotation of the reel using the weight of the refill, namely the load of the reel included in the refill to be applied to the transfer tool main body, both preventing a reel from unnecessary rotating by the refill itself during transportation and permitting rotation of the reel smoothly during use can be achieved with a simple constitution of the transfer tool main body.

By the way, in view of the fact that almost refills are usually unused ones at the time of being attached to the transfer tool main body, if the reel includes a feeding reel to feed the transfer tape wound around it and a winding reel to wind up the transfer tape fed from the feeding reel and wrapped around the transfer head, it is desirable that the rotation-inhibiting mechanism be able to inhibit rotation of the feeding reel which winds up most of the transfer tape positioned upstream of the transfer head before use.

As a specific configuration of the rotation-inhibiting mechanism, it is preferable that the rotation-inhibiting mechanism be provided between the reel and a refill base holding the reel.

As a configuration that be able to effectively inhibit rotation of the reel during transportation, the rotation-inhibiting mechanism can be cited that the rotation-inhibiting mechanism has a plurality of openings provided on the reel, a rotation-inhibiting end to be inserted into the opening and able to inhibit rotation of the reel, and an elastic deformation part to be elastically deformed with a load transmitted from the reel so as to move the rotation-inhibiting end out of the opening.

In order to inhibit rotation of the reel more surely and keep the inhibiting condition effectively, it is desirable that the opening be opened in the axial direction of the reel, and besides the rotation-inhibiting end be able to approach to and be moved away along the axial direction.

In order to be able to perform the function of the rotation-inhibiting mechanism more certainly when attaching the reel, it is desirable that the rotation-inhibiting mechanism have a contacting end that is able to contact the transfer tool main body before the reel is attached to the transfer tool main body.

### Effects of the Invention

According to the present invention, a transfer tool and a refill to be used for the transfer tool are provided that can achieve both preventing a reel from unnecessary rotating by the refill itself during transportation and permitting rotation of the reel smoothly when in use with a simple constitution of a transfer tool main body.

### BRIEF DESCRIPTION OF THE DRAWINGS

FIG. 1 is a front view showing an embodiment of the present invention.

FIG. 2 is a plan view showing the embodiment.

FIG. 3 is a perspective view showing the embodiment.

FIG. 4 is an exploded perspective view showing the embodiment.

FIG. 5 is a perspective view showing the essential part of the embodiment.

FIG. 6 is an exploded longitudinal section taken along the center showing the embodiment.

FIG. 7 is an explanatory diagram showing the action of the embodiment corresponding to FIG. 6.

FIG. 8 is a partial perspective view showing the essential part of the embodiment.

FIG. 9 is an explanatory diagram showing the action of the embodiment corresponding to FIG. 8.

### MODE FOR CARRYING OUT THE INVENTION

Described below is one embodiment of the present invention with reference to the drawings.

A transfer tool 1 according to the present embodiment includes a refill 3 which holds a transfer tape T in a state of winding a feeding reel 32 as a reel and a winding reel 33, and a transfer tool main body 2 on which the refill 3 is installed.

In the transfer tool 1 according to the embodiment, the refill 3 has a rotation-inhibiting mechanism X as well as the feeding reel 32 wound with the transfer tape T. The rotation-inhibiting mechanism X inhibits rotation of the feeding reel 32 when the feeding reel 32 is not held in the transfer tool main body 2, and besides the rotation-inhibiting mechanism X is able to permit rotation of the feeding reel 32 with a reaction to transmitting a load from the feeding reel 32 to the transfer tool main body 2 when the feeding reel 32 is attached to the transfer tool main body 2.

Configurations of respective parts in the transfer tool 1 will be described.

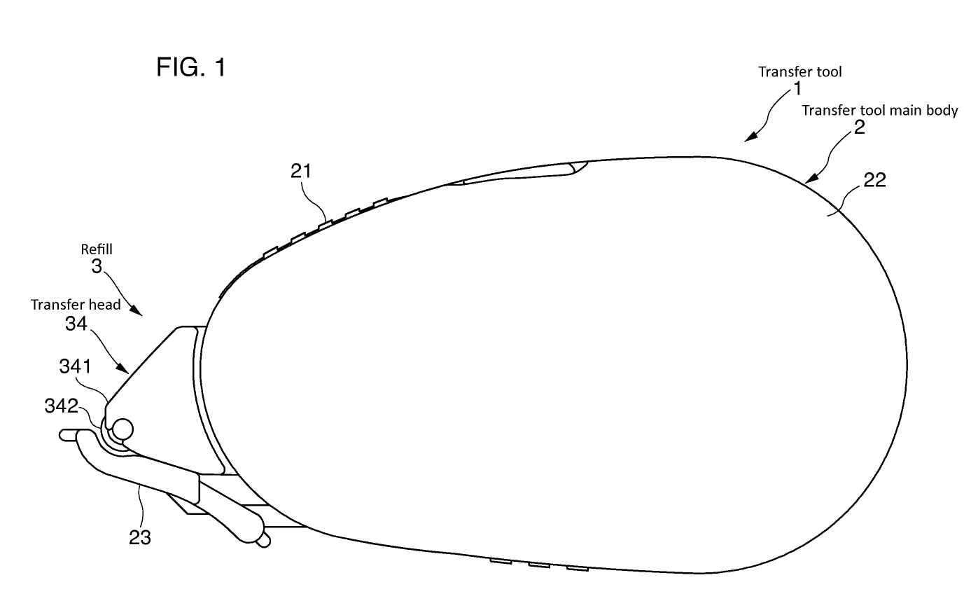

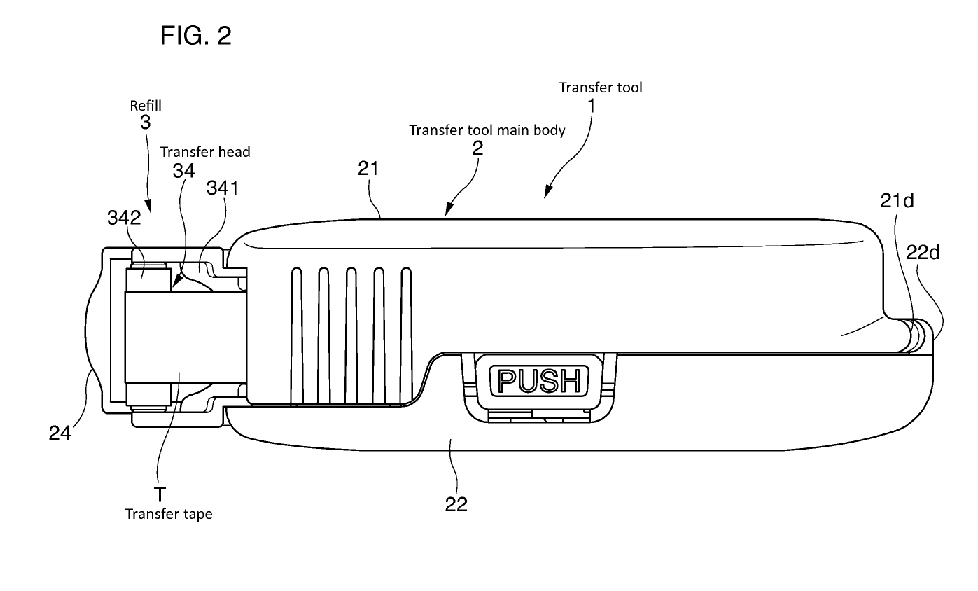

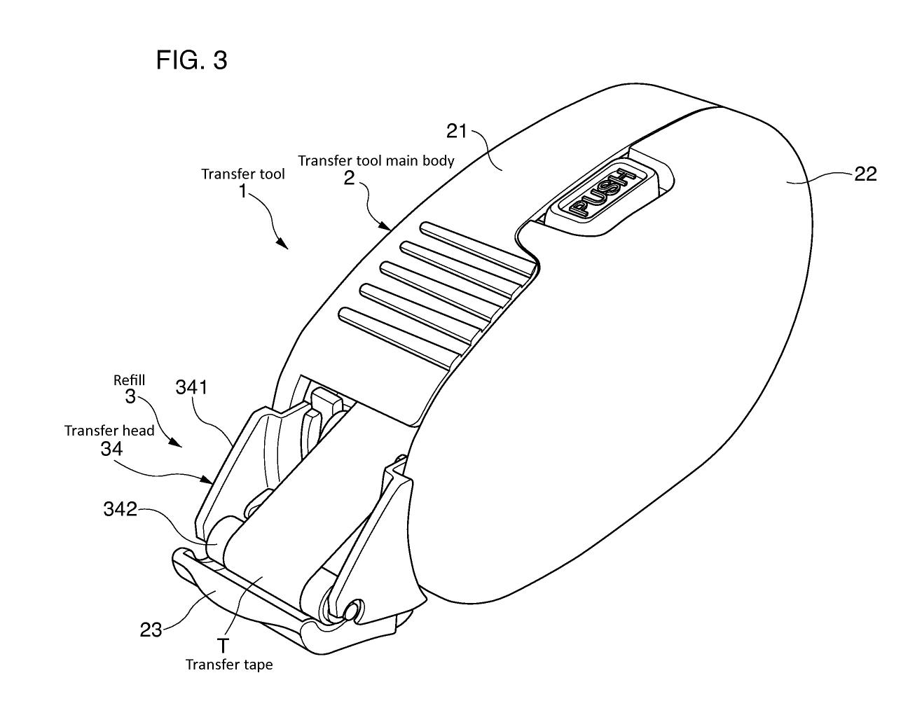

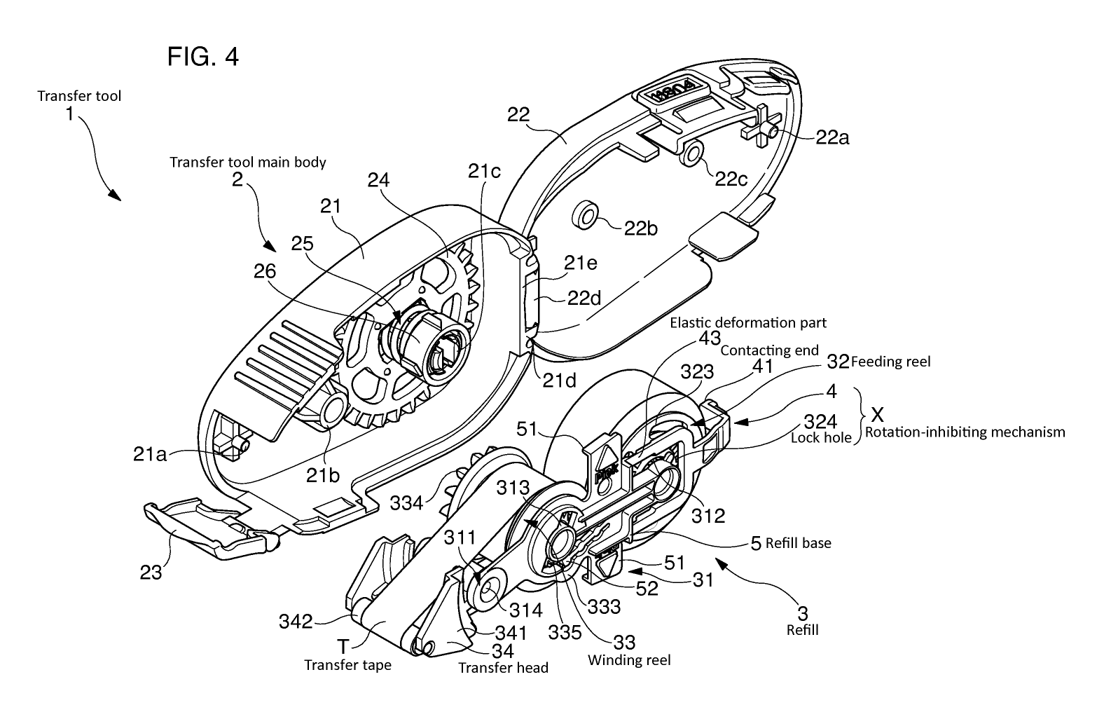

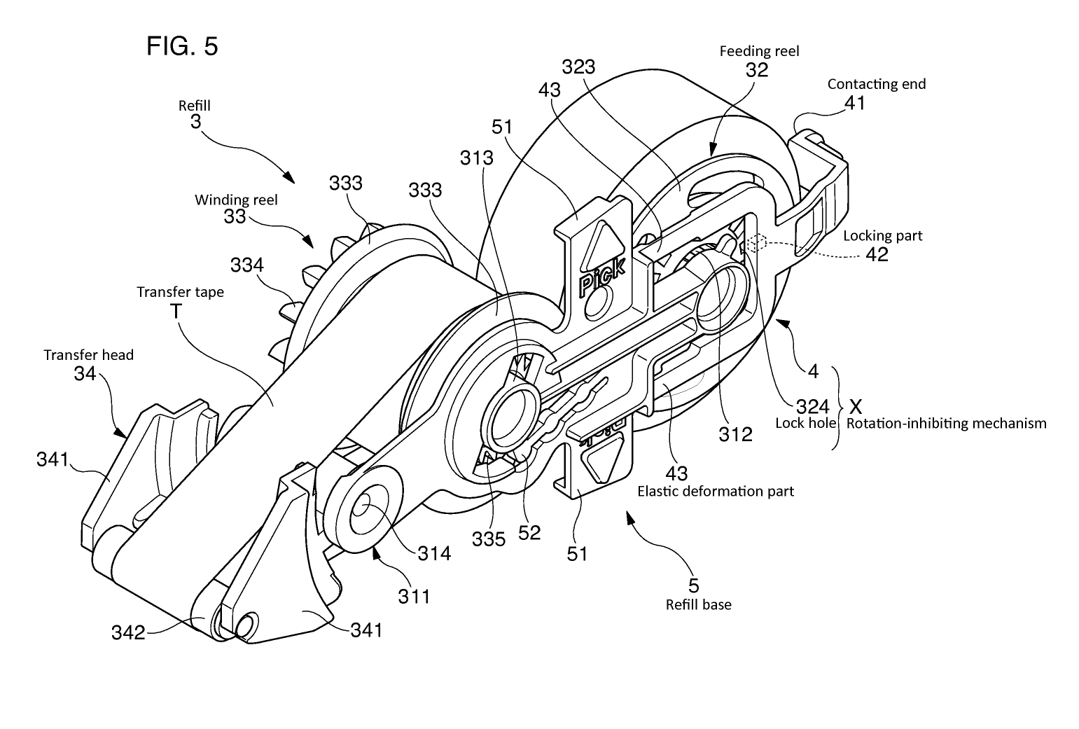

As shown in FIGS. 1 to 5, the refill 3 has a refill body 31 integrally molded of resin, the feeding reel 32 mounted on the refill body 31, the winding reel 33 mounted on the refill body 31, and a transfer head 34. The refill body 31 has a plate-like refill base 5, an attachment part 311 to be attached to the transfer tool main body 2, a feeding side shaft 312 supporting the feeding reel 32, a winding side shaft 313 supporting the winding reel 33, and a rotation-inhibiting part 4 integrally provided with the refill base 5. The refill base 5 connects one end side of the refill 3 to the other end side thereof approximately along a straight line via the transfer head 34, the winding reel 33 and the feeding reel 32. The refill base 5 has catch parts 51 that exist between the feeding reel 32 and the winding reel 33 and protrude marginally more outward than the transfer tape T wound around the feeding reel 32 in a front view, and a pawl 52 to prevent the winding reel 33 from reversing by engaging a top end thereof with the winding reel 33. The attachment part 311 has a cylindrical shape protruding in the thickness direction on one end side of the refill base 5 and is attached to the transfer tool main body 2 with an attachment hole 314 provided in the cylinder. The feeding side shaft 312 supports the feeding reel 32 so that the feeding reel 32 does not come off and is rotatable. The winding side shaft 313 supports the winding reel 33 so that the winding reel 33 does not come off and is rotatable. A top end of the feeding side shaft 312 and a top end of the winding side shaft 313 come into contact with the transfer tool main body 2 and position the refill 3 in the thickness direction. Also, the rotation-inhibiting part 4 has a locking part 42 as a rotation-inhibiting end that is able to be engaged with the feeding reel 32 and inhibit rotation of the feeding reel 32, a contacting end 41 that is able to contact the transfer tool main body 2, and an elastic deformation part 43 to be elastically deformed with a load transmitted from the reel so that the locking part 42 is disengaged from the feeding reel 32 when the contacting end 41 contacts the transfer tool main body 2. The feeding reel 32 is supported by the feeding side shaft 312 of the refill body 31 and wound with the transfer tape T. The feeding reel 32 is integrally molded of resin. The feeding reel 32 has a shaft hole part 321 to be supported by the refill body 31, a body part 322 on which the transfer tape T is wound, and flanges 323 to prevent slippage of the wound transfer tape T. In the embodiment, a plurality of lock holes 324 are provided as openings on an peripheral part of the flange 323 in the feeding reel 32, the lock holes 324 being arranged along a circle. The winding reel 33 is supported by the winding side shaft 313 of the refill body 31 and wind up the transfer tape T as the transfer tool 1 is used. The winding reel 33 has a shaft hole part 331 to be supported by the refill body 31, a body part 332 on which the transfer tape T is wound up after transferring transfer substances, and flanges 333 to prevent slippage of the wound transfer tape T. In the embodiment, ratchet teeth 335 with which the pawl 52 is engaged are provided on the flange 333 at the side of the refill body 31 so as to constitute a reverse-inhibit mechanism. A winding gear 334 with which the transfer tool main body 2 is engaged is integrally formed on the other flange 333 opposed to the above flange 333 so as to constitute an interlocking mechanism.

The transfer head 34 has a frame 341 that is integrally formed with the attachment part 311 of the refill body 31, and a transfer roller 342 that is supported by the frame 341. The frame 341 is composed of plate-like parts integrally provided with the attachment part 311, a pair of guides being formed into an approximately triangular shape is provided in top end regions on both sides of the frame 341 to prevent lateral slippage of the wound transfer tape T. The transfer roller 342 is attached between the top ends of the guides so that the transfer roller 342 is rotatable.

The transfer tool main body 2 is able to accommodate the transfer tape T as well as the refill 3. The transfer tool main body 2 has a first case 21, a second case 22 attached to the first case 21 so that the second case 22 is turnable, a cap 23 attached to the first case 21 so that the cap 23 is turnable, a feeding gear 24 mounted on the first case 21, and a rotating end 26 attached to the feeding gear 24 with a clutch 25 intervening between them. The first case 21 covers the refill 3 nearly from the rear to the side. The first case 21 has a first attachment rib 21a to fix the attachment part 311 of the refill body 31, a winding shaft 21b to support the winding reel 33 directly, a feeding shaft 21c to support the feeding reel 32 indirectly, and a first hinge part 21d that is turnably engaged with the second case 22 and able to constitute a hinge. The second case 22 is composed of a transparent resin and covers the front of the refill 3. The second case 22 has a second attachment rib 22a to fix the attachment part 311 of the refill body 31, a feeding side pressing part 22b to press the feeding reel 32 after installing the refill 3, a winding side pressing part 22c to press the winding reel 33 after installing the refill 3, and a second hinge part 22d that is engaged with the first hinge part 21d so as to constitute the hinge. A cap 23 turnably attached to the first case 21 is able to be positioned on the capping attitude where the transfer head 34 is capped so as to prevent the transfer head 34 from touching an object around it when in not use besides on the usable attitude where the cap 23 abuts on the first case 21 and the transfer head 34 is exposed out of the transfer tool main body 2 when in use. The feeding gear 24 is attached to the feeding shaft 21c so that the feeding gear 24 does not come off and is rotatable, the rotating end 26 is attached to the top end side of the feeding shaft 21c. More specifically, the feeding gear 24 has a gear part in a disk shape and a top end part near to the top end side of the feeding shaft 21c, the top end part being formed into an overhanging shape. And, the rotating end 26 is pressed against the overhanging part away from the disk shape part, for example, by attaching a metal spring so as to constitute the clutch 25.

In this way, the refill 3 of the transfer tool 1 according to the embodiment, as described above, has the rotation-inhibiting mechanism X to inhibit rotation of the feeding reel 32 wound with the transfer tape T when the reel is not held in the transfer tool main body 2, the rotation-inhibiting mechanism X being able to permit rotation of the reel with loading the transfer tool main body with the reel when the reel is attached to the transfer tool main body.

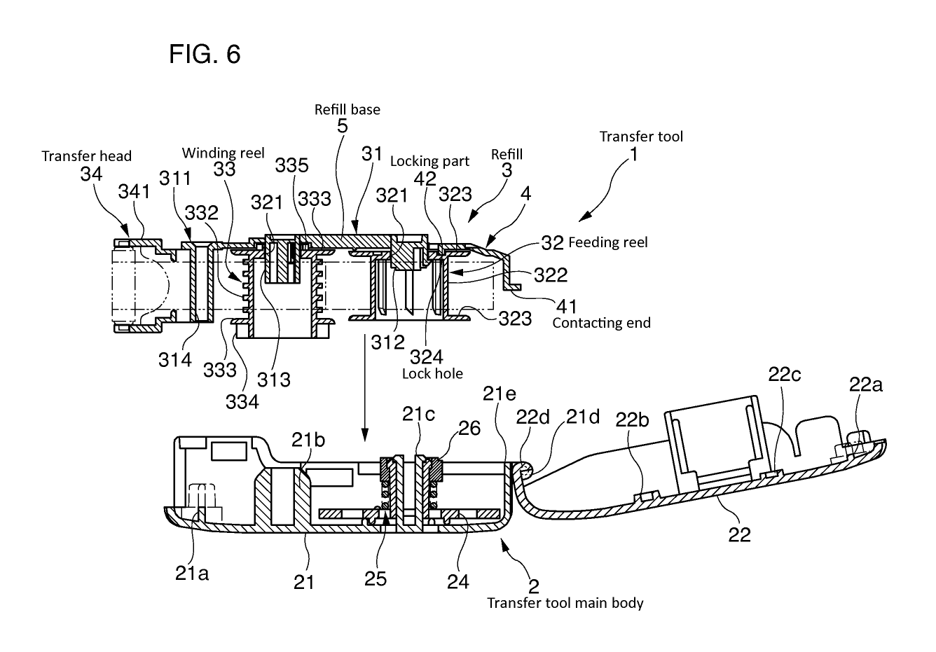

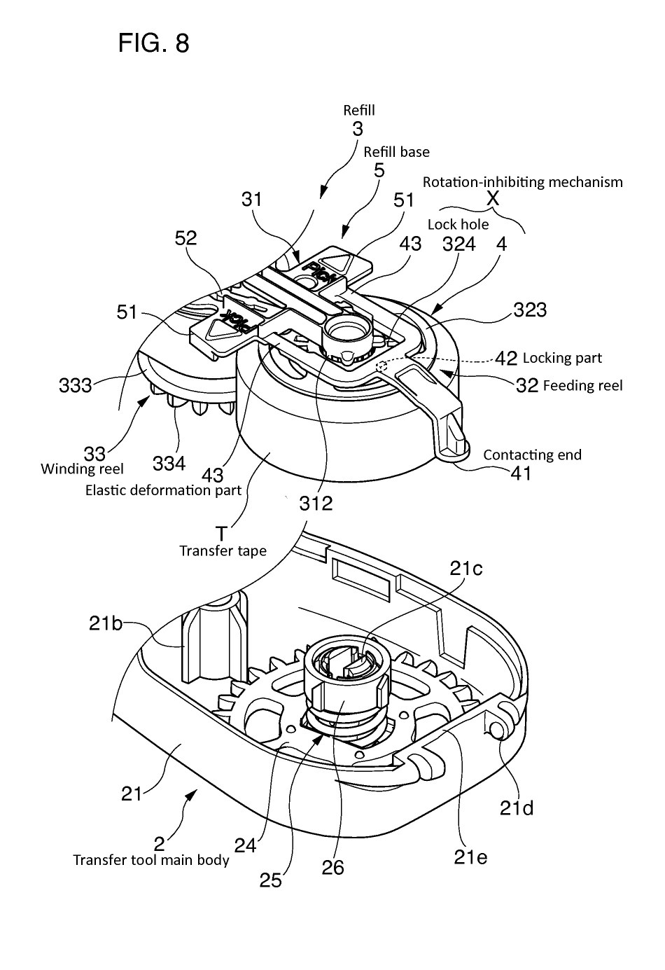

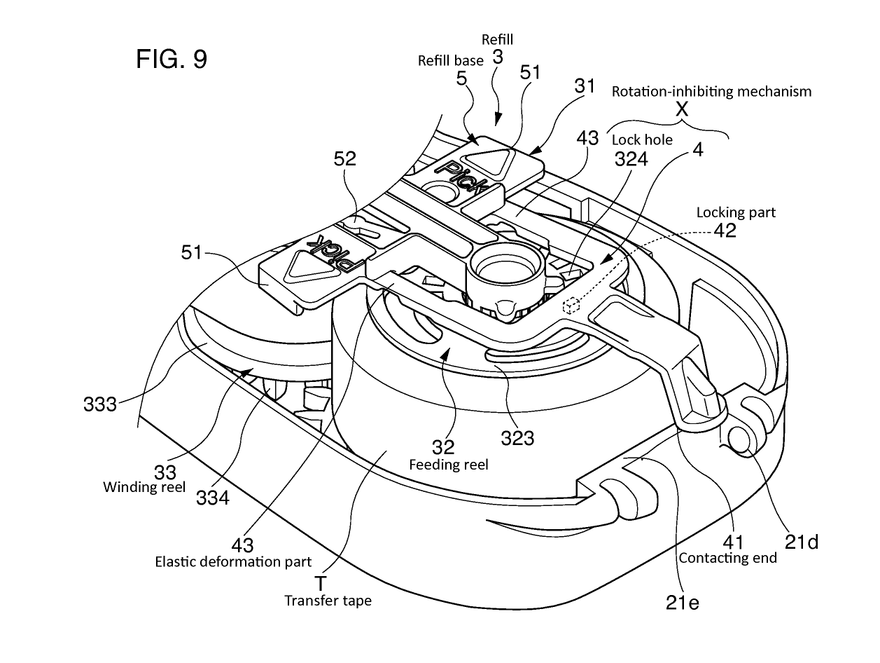

Action of the rotation-inhibiting mechanism X while the refill 3 is installed on the transfer tool main body 2 will be described referring to FIGS. 6 to 9. For convenience of explanation, the second case 22 is omitted in FIGS. 8 and 9.

The rotation-inhibiting mechanism X is constituted of the rotation-inhibiting part 4 provided on the refill base 5 that is a component of the refill body 31 and the lock holes 324 provided on the feeding reel 32. In other words, the rotation-inhibiting mechanism X is provided between the feeding reel 32 and the refill base 5.

First, as shown in FIGS. 6 and 8, the locking part 42 being a component of the rotation-inhibiting part 4 inhibits rotation of the feeding reel 32 by being inserted into the lock hole 324 that is provided on the feeding reel 32 and opened in the axial direction of the feeding reel 32.

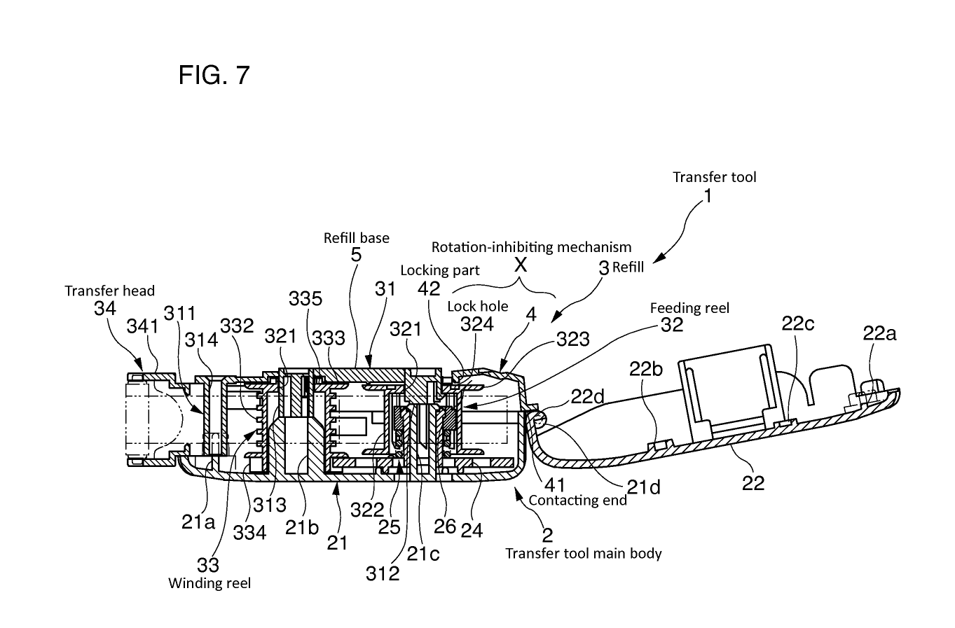

Then, as shown in FIGS. 7 and 9, the refill 3 is put on to install the refill 3 in a state that the feeding reel 32, the winding reel 33 and the attachment part 311 are set at the rotating end 26, the winding shaft 21b and the first attachment rib 21a, respectively. The contacting end 41 of the rotation-inhibiting part 4 consequently contacts an edge part of the first case 21. At this time, the refill base 5 is sunk by weight of the feeding reel 32 and the transfer tape T wound around the feeding reel 32, that is, weight of the refill 3 itself. And, the locking part 42 is moved out of the lock hole 324 by deforming the elastic deformation part 43 elastically as the refill base 5 is sunk. In detail, the contacting end 41 becomes a fulcrum and the feeding side shaft 312 becomes the point where force is applied when the contacting end 41 contacts the edge part. The locking part 42 accordingly becomes the point of action, quick movement of the locking part 42 away from the lock hole 324 is obtained. According to this embodiment, the quick movement of the locking part 42 is ensured because the locking part 42 to be the point of action is provided between the contacting end 41 to be the fulcrum and the feeding side shaft 312 to be the point where force is applied.

When the second case 22 is turned and closed, the winding side pressing part 22c and the feeding side pressing part 22b of the second case 22 are located adjacent to the winding side shaft 313 and the feeding side shaft 312 of the refill body 31, respectively. Hence, the refill 3 will contact the second case 22 and be settled even if the refill 3 moves in the thickness direction when in use. Therefore the locking part 42 is always set out of the lock hole 324 in the state that the second case 22 is closed.

With such configurations as described above, the transfer tool according to the embodiment, which is provided with the rotation-inhibiting mechanism X using the weight of the refill 3, achieves both preventing the reel from unnecessary rotating by the refill 3 itself during transportation and permitting rotation of the reel smoothly when in use as well as the transfer tool main body 2 is simply constituted.

The rotation-inhibiting mechanism X that inhibits rotation of the feeding reel 32 can permit the rotation of the feeding reel 32 using the weight of the transfer tape T on the unused refill 3 effectively.

And, providing the rotation-inhibiting mechanism X between the feeding reel 32 and the refill base 5 keeps the refill 3 itself compact in an effective manner.

According to this embodiment, the lock holes 324 as a plurality of openings provided on the feeding reel 32 as the reel, the locking part 42 to be inserted into the lock hole 324 and able to inhibit rotation of the feeding reel 32 and the elastic deformation part 43 to be elastically deformed with a load transmitted from the feeding reel 32 so as to move the locking part 42 out of the lock hole 324 constitute the rotation-inhibiting mechanism X with a simple configuration.

According to this embodiment, the configuration in which the lock holes 324 are opened in the axial direction of the feeding reel 32 and the locking part 42 is able to approach to and be moved away along the axial direction is employed in order to keep the condition of inhibiting rotation of the feeding reel 32 effectively.

Also, according to this embodiment, the contacting end 41 is provided to be able to contact the transfer tool main body 2 before the feeding reel 32 is attached to the transfer tool main body 2 and the locking part 42 is provided between the elastic deformation part 43 and the contacting end 41 in order to be able to perform the function of the rotation-inhibiting mechanism X more certainly when attaching the reel.

While the embodiment of the present invention is described above, the concrete structures of the respective components is not limited to the above-described embodiment and various modifications are possible without departing from the scope and spirit of the present invention.

For example, even though the mode of permitting rotation of the reel by using the movement of the refill in the thickness direction with the weight of the refill is disclosed in the above-described embodiment, of course direction of movement of the refill is not limited as far as the movement is with the weight of the refill. Even though the mode of providing the rotation-inhibiting mechanism on the side of one of the two reels, namely the feeding reel that winds up most of the transfer tape before use is disclosed in the above-described embodiment, of course a rotation-inhibiting mechanism may be provided on the side of the winding reel, or rotation-inhibiting mechanisms may be provided on both reels. As an example, if the rotation-inhibiting mechanism is provided on the side of the winding reel, the configuration in which a ratchet teeth is used at the position of the above-described reverse-inhibit mechanism can be employed. Even though the mode of using the metal spring to constitute the clutch is disclosed in the above-described embodiment, of course a clutch may be provided with using friction between members that are engaged with each other. Interlocking the feeding reel with the winding reel does not always use the gears. The configuration in which a belt is wrapped around a pulley provided on the side of feeding and a pulley provided on the side of winding so that the belt is able to slip on the pulleys can be employed. In addition, the specific configurations, for example, the width of the tape or the property of the transfer substance itself are not limited to the above-described embodiment and various modifications including existing ones are possible.

Regarding to the concrete structures of the respective components, various modifications are possible without departing from the scope and spirit of this invention.

### INDUSTRIAL APPLICABILITY

The present invention may be used as a transfer tool with a refill and the refill for the transfer tool that has a reel to wind a transfer tape provided with a transfer substance and a rotation-inhibiting mechanism to inhibit rotation of the reel when it is not in use.

### Description of the Reference Numeral

1 transfer tool
2 transfer tool main body
3 refill
32 feeding reel
324 opening (lock hole)
33 winding reel
34 transfer head
41 contacting end
42 rotation-inhibiting end (locking part)
43 elastic deformation part
5 refill base
T transfer tape
X rotation-inhibiting mechanism

1. A transfer tool comprising:
a transfer tool main body capable of accommodating a transfer tape that is able to transfer a transfer substance onto a transfer target by pressing the transfer tape against the transfer target in a state of wrapping the transfer tape around a transfer head; and
a refill capable of being installed on the transfer tool main body, the refill having a reel to wind the transfer tape and a rotation-inhibiting mechanism to inhibit rotation of the reel when the reel is not held in the transfer tool main body, the rotation-inhibiting mechanism being able to permit rotation of the reel with loading the transfer tool main body with the reel when the reel is attached to the transfer tool main body.

2. The transfer tool according to claim 1, wherein
the reel includes a feeding reel to feed the transfer tape wound around it and a winding reel to wind up the transfer tape fed from the feeding reel and wrapped around the transfer head,
the rotation-inhibiting mechanism is able to inhibit rotation of the feeding reel.

3. The transfer tool according to claim 1, wherein
the rotation-inhibiting mechanism is provided between the reel and a refill base holding the reel.

4. The transfer tool according to claim 1, wherein
the rotation-inhibiting mechanism has a plurality of openings provided on the reel, a rotation-inhibiting end to be inserted into the opening and able to inhibit rotation of the reel, and an elastic deformation part to be elastically deformed with a load transmitted from the reel so as to move the rotation-inhibiting end out of the opening.

5. The transfer tool according to claim 4, wherein
the opening is opened in the axial direction of the reel, and besides the rotation-inhibiting end is able to approach to and be moved away along the axial direction.

6. The transfer tool according to claim 1, wherein
the rotation-inhibiting mechanism has a contacting end that is able to contact the transfer tool main body before the reel is attached to the transfer tool main body.

7. A refill to be used while at least a part of the refill is put in a transfer tool main body capable of accommodating a transfer tape that is able to transfer a transfer substance onto a transfer target by pressing the transfer tape against the transfer target in a state of wrapping the transfer tape around a transfer head, comprising:
a reel to wind the transfer tape; and
a rotation-inhibiting mechanism to inhibit rotation of the reel when the reel is not held in the transfer tool main body, the rotation-inhibiting mechanism being able to permit rotation of the reel with loading the transfer tool main body with the reel when the reel is attached to the transfer tool main body.
